(19) United States
(12) Patent Application Publication
(10) Pub. No.: US 2025/0238534 A1
(43) Pub. Date: Jul. 24, 2025

(54) DATA PROTECTION

(71) Applicant: STMicroelectronics International N.V., Geneva (CH)

(72) Inventor: Michel JAOUEN, YvreL'Eveque (FR)

(73) Assignee: STMicroelectronics International N.V., Geneva (CH)

(21) Appl. No.: 19/020,407

(22) Filed: Jan. 14, 2025

(30) Foreign Application Priority Data
Jan. 18, 2024 (FR) FR2400497

(51) Int. Cl. G06F 21/62; G06F 21/60

(52) U.S. Cl. CPC G06F 21/62; G06F 21/602; G06F 2221/2107

(57) ABSTRACT

An electronic device receives a software module of a first application, where the software includes comprising a public key associated with the first application. A cryptographic circuit of the electronic device generates an encryption key based on a secret key of the electronic device and on one of: the public key or and an identification value derived from the public key. The cryptographic circuit then generates one or more protected data items by application of a cryptographic operation to one or more first data items associated with the first application and based on the encryption key. The one or more protected data items are then stored in a first portion of a memory of the electronic device.

### PRIORITY CLAIM

This application claims the priority benefit of French Application for Patent No. 2400497, filed on Jan. 18, 2024, the content of which is hereby incorporated by reference in its entirety to the maximum extent allowable by law.

### TECHNICAL FIELD

The present disclosure generally concerns the protection of data generated and/or used by an application implemented by an electronic device.

### BACKGROUND

It is common practice to use electronic devices and systems configured to execute a plurality of different functionalities, themselves implemented by software applications.

It would be desirable to be able to improve, at least partly, certain aspects of software architectures. More particularly, it would be desirable to be able to improve, at least partly, certain aspects of the security of data manipulated by software applications. For example, it is generally desirable for a software application installed in a device not to have access to the secrets of other software applications installed and/or previously installed in the device.

### SUMMARY

An embodiment provides a method comprising: a) receiving, by an electronic device, a software module of a first application, the software module comprising a public key associated with the first application; b) generating, by a cryptographic circuit of the electronic device, of an encryption key based on a secret key of the electronic device and on one of: the public key and an identification value derived from the public key; c) generating one or a plurality of protected data by application of a cryptographic operation, by the cryptographic circuit, to one or a plurality of first data items associated with the first application and based on the encryption key; and d) storing the one or a plurality of protected data items in a first portion of a memory of the electronic device.

According to an embodiment, the cryptographic operation comprises encrypting, by using the encryption key, the one or a plurality of first data items.

According to an embodiment, application of the cryptographic operation comprises calculating one or a plurality of first signature values associated with the one or a plurality of first data items by using the encryption key, the one or a plurality of protected data comprising the one or a plurality of first signature values.

According to an embodiment, the encryption key corresponds to a secret key derived by application of a key derivation function by the cryptographic circuit based on the identification value, the identification value resulting from a hashing of the public key.

According to an embodiment, the software module comprises an execution code, and a second signature value associated with the execution code, the method further comprising, prior to the generation of the one or a plurality of protected data items, authenticating the software module based on a verification of the second signature value via the public key.

According to an embodiment, the above method further comprises storing the execution code in a second portion of the memory distinct from the first portion.

According to an embodiment, steps a) to d) are carried out via a software platform of the electronic device.

According to an embodiment, the above method further comprises, prior to the carrying out of step b): generating a verification value by applying a hash function to the public key; comparing the verification value with the identification value; and when the verification value and the identification value do not match, removing the software module.

According to an embodiment, the above method further comprises generating the identification value, by application of a hash function, by the cryptographic circuit, to the public key.

According to an embodiment, the secret key of the electronic device is a hardware unique key or a key derived from a hardware unique key.

According to an embodiment, the method further comprises modifying the public key during an update of the first application.

According to an embodiment, the above method further comprises executing the first application, by a processor of the device, wherein executing comprises retrieving the one or a plurality of first data items associated with the first application, by performing: extracting the public key and a new generation of the encryption key based on a secret key of the electronic device and on one of: the public key and an identification value derived from the public key; applying a new cryptographic operation on the one or a plurality of protected data items stored in the first portion of the memory; and retrieving the one or a plurality of first data items.

According to an embodiment, retrieving the one or a plurality of first data items is performed via a software platform of the electronic device.

An embodiment provides an electronic device configured to: receive a software module of a first application, the software module comprising a public key, the electronic device comprising: a cryptographic circuit configured to: generate an encryption key based on one of: the public key and an identification value derived from the public key; generate one or a plurality of protected data items by applying a cryptographic operation to one or a plurality of first data items associated with the first application based on the encryption key; and a memory configured to store the one or a plurality of protected data items.

According to an embodiment, the above electronic device further comprises a software platform configured to control the access to the memory.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a block diagram illustrating an electronic device;

FIG. 2 shows, very schematically and in the form of blocks, an embodiment of a software system;

FIG. 3 illustrates the structure of a software application module; and

FIG. 4 is a flowchart illustrating steps of a verification method.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

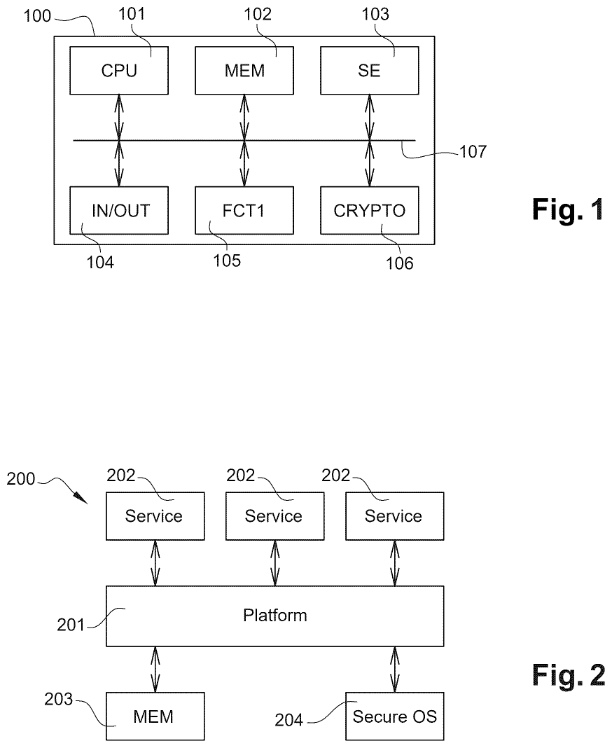

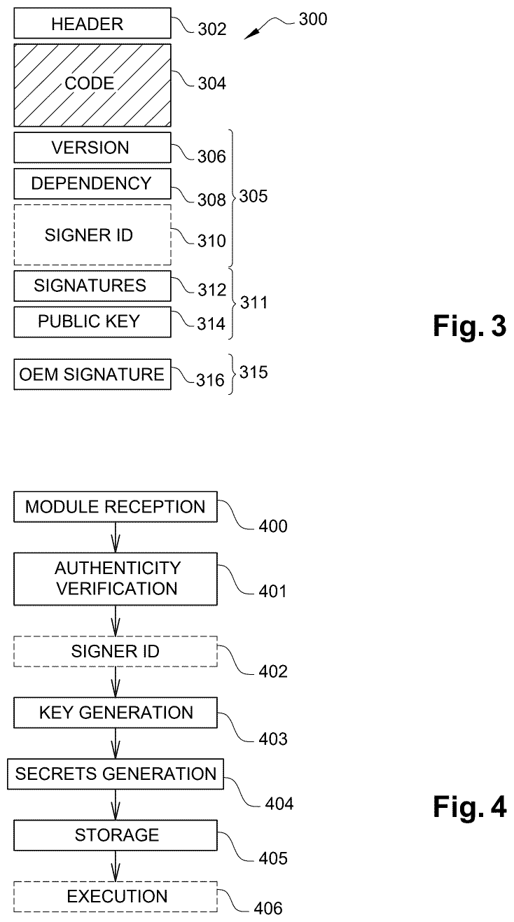

FIG. 1 is a block diagram very schematically showing an architecture of an example of an electronic device 100 configured to implement the software system described in relation with FIG. 2, and/or to storing and executing the software module such as described in relation with FIG. 3, and/or to implementing the method described in relation with FIG. 4.

Electronic device 100 comprises a processor 101 (CPU) configured to process data items stored in memories and/or provided by other circuits of device 100. Processor 101 may also be configured to implement a software architecture of the type of the software architecture described in relation with FIG. 2.

Electronic device 100 comprises, for example, one or a plurality of memories 102 (MEM), among which, for example, a non-volatile memory, a volatile memory, and/or a read-only memory. Each memory 102 may be configured to store different types of data, and may comprise access rules. In particular, memory or memories 102 may comprise portions which are accessible only to one or a plurality of circuits of the electronic device, and/or only to one or a plurality of software programs implemented by device 100.

Electronic device 100 further comprises, for example, a secure element 103 (SE) configured to handle sensitive and/or secret data. Secure element 103 may comprise its own processor(s), its own memory or memories, etc. Secure element 103 may also be configured to implement a software architecture of the type described in relation with FIG. 2.

What is referred to in the rest of the disclosure as sensitive data and secret data means data having a content which is not intended to be made public. For example, these data are not known outside of electronic device 100, and/or the access to these data is restricted to certain specific persons and/or circuits.

Electronic device 100 may further comprise one or a plurality of interface (or input/output) circuits 104 (IN/OUT) configured to send data to the outside of device 100 and/or to receive data from the outside of device 100. Interface circuits 104 may further be configured to communicate with a data display system, for example, a screen.

Electronic device 100 may further comprise one or a plurality of circuits 105 (FCT1) configured to perform functions. As an example, circuits 105 may comprise measurement circuits, data conversion circuits, circuits for controlling electronic or electromechanical equipment, etc. Electronic device 100 may further comprise, in addition to or instead of secure element 103, one or a plurality of cryptographic circuits 106 configured to perform cryptographic operations such as, for example, asymmetric and/or symmetric encryption/decryption operations, calculations of signature values of one or a plurality of data items, hash operations, such as SHA256, etc.

Electronic device 100 comprises, for example, one or a plurality of data buses 107 configured to transfer data between processor 101 and the one or a plurality of memories 102, and in certain cases also between one or a plurality of the other components 103, 104, 105, and 106 of electronic device 100.

FIG. 2 shows, very schematically and in the form of blocks, an embodiment of a software architecture, or software system 200.

Architecture, or system, 200 comprises, for example: a shared and secure software platform 201 (Platform); one or a plurality of secure software applications 202 (Service); one or a plurality of memories 203 (MEM); and at least one secure operating system 204 (Secure OS).

Shared software platform 201 is software used to implement application(s) 202. More particularly, platform 201 is configured to communicate with the applications, that is, to receive and transmit data thereto. According to an embodiment, platform 201 is configured to manage the storage of the data used by software application(s) 202. According to an example, software platform 201 is designed by an original equipment manufacturer (OEM), or manufacturer, different from that of the electronic device, such as the processor or the secure element, implementing it.

What is referred to herein as the original equipment manufacturer, or simply manufacturer, means the initial designer of an element, such as a circuit, a device, or software.

Secure software application(s) 202 (Service) is/are secure software configured to implement one or a plurality of functionalities. Each application 202 may also be referred to as a software service, or simply a service. According to an embodiment, an application 202 is implemented based on its execution code, and may generate and/or use data associated with the application, also referred to hereafter as digital assets (Assets).

What is referred to herein as the execution code means the set of data and instructions forming the program(s) implemented by an application. When an application is updated, its execution code is modified.

Further, what is referred to herein as a digital asset means one or a plurality of data items generated by the application during its operation and/or used during and by the application for its operation. These data items can be collected, generated, and/or processed by said application. A digital asset may be a data item temporarily stored by the application, or more durably stored by the application. When an application is updated, the digital assets are not modified. Indeed, it is desirable for an updated version of the application to have access to, and to be able to use, data associated with the previous version(s). A digital asset is generally considered as a sensitive and/or secret data item.

According to an embodiment, each software application 202 may be designed by a manufacturer different from the designer of software platform 201 and from the manufacturer of the electronic device, such as the processor or secure element implementing them. Similarly, different applications may have different manufacturers.

Each application 202 is configured to communicate with platform 201, and, more generally, is configured to be implemented or executed by platform 201.

Memory 203 represents the accesses to the various memories of the device implementing system 200. Among these memories, there exists, for example, at least a portion of a memory having its access strictly reserved for platform 201, and at least a portion of a memory used for the storage of the digital assets of applications 202. For example, platform 201 may be configured for managing memory accesses. Applications 202, for example, do not have a direct access to memories 203.

Secure operating system 204 is, for example, the operating system of the electronic device, such as a processor or a secure element, implementing system 200. Operating system 204 is, for example, configured to communicate with platform 201, but also, according to an example not shown, with memories 203 and applications 202.

The embodiments described hereafter relate to the security of software applications, such as applications 202, and more particularly to the security of the digital assets of such software applications. It is more specifically aimed at preventing a software application from accessing digital assets which are not intended for it, such as digital assets of another software application, or digital assets of an older version of a same software application of another application provider, such as another original equipment manufacturer, another circuit manufacturer, and/or a third party.

The embodiments described hereafter enable, in particular, to overcome an application substitution attack, in which a pirate application takes the place of an already-installed application by pretending to be it during an update, with the aim of gaining access to digital assets of the application.

FIG. 3 illustrates the structure of a software module 300 of a software application, according to an embodiment of the present disclosure.

Software module 300 is, for example, a module of a software application received by device 100, via interface circuits 104. As an example, software module 300 is a module of an application which is not already installed in device 100. In another example, software module 300 is a module enabling the update of a pre-existing application of device 100, for example the update of an application 202.

Software module 300 comprises a header 302 (HEADER) comprising information, for example, relative to the format of the image of the application, its installation location for its execution in the memory, the size of the execution code, etc.

Software module 300 further comprises an execution code 304 (CODE). As an example, the execution code is encrypted, for example via a symmetric key known only to the sender of software module 300. As an example, the symmetric key is encrypted by means of a pair of asymmetric keys. In particular, the public key of the pair of asymmetric keys is used to encrypt the symmetric key. The private key is, for example, stored in device 100 and used to decrypt the symmetric key. As an example, the symmetric key is comprised in the image format of the application. Thus, the private key only being known to device 100, it may also be used to encrypt other software applications, for example originating from different authorities. In order for the private key to be unknown to an original equipment manufacturer, or to a third party, the private key is, for example, stored in device 100 on manufacturing thereof. As an example, the private key is provisioned in device 100 by the manufacturer of device 100, or by an authority, such as for example the manufacturer of a component of device 100, independent from the software applications.

Software module 300 further comprises information 305 comprising, for example, an indication 306 of the version (VERSION) of the application. Information 305 further comprises, for example, indications 308 of the software dependencies (DEPENDENCY) of the application. As an example, indications 308 indicate to device 100 software and/or hardware components used for the correct operation of the application. As an example, information 305 comprises an identification value 310 (SIGNER ID). In an example, device 100 is a connected object and the identification value is, for example, used to play the role of a token for the implementation of an initial attestation token service, enabling to deliver information relative, for example, to the state of the software to, for example, a remote server.

According to an embodiment, on installation of software module 300, an encryption key for encrypting and/or decrypting assets is generated, for example by cryptographic circuit 106, based on the identifier value and on a secret key specific to device 100. As an example, the secret key is a hardware unique key (HUK) or a key derived from a hardware unique key (“Derived Hardware Unique Key”—DHUK). As an example, the encryption key is obtained by derivation of the secret key by identification value 310. According to an embodiment, the generated encryption key is used to encrypt one or a plurality of digital assets associated with the application. According to another embodiment, the received encryption key is used to calculate one or a plurality of signature values, associated with the one or a plurality of assets. The one or a plurality of assets are stored, for example encrypted or signed via the encryption key, in a non-volatile memory of the device. As an example, the one or a plurality of assets have been received by device 100 during the execution of the software. As an example, the software is configured to drive a keyboard and/or a screen and to request the user to enter a password. In another example, the software is configured to control the connection to a server which, as a result of the execution of an authentication procedure based on identification value 310, will deliver assets to the software. Thus, identification value 310 is comprised in the software image and is, for example, further used in the function of calculation of the encryption key.

Software module 300 further comprises data 311, associated for example with a third party, the third party being an entity different from the original equipment manufacturer. In certain cases, the third party is, for example, the manufacturer of device 100. In other cases, the third party is an entity completely different from the manufacturer of device 100. Generally, the third party represents the entity having, for example, designed software module 300 and, in particular, the code 304. Data 311 comprise, for example, one or a plurality of signature values 312 (SIGNATURES). As an example, signature(s) 312 comprise a signature of code 304, for example generated by the third party based on a private key unknown to device 100. Data 311 further comprise a public key 314 (PUBLIC KEY). Public key 314 is, for example, a key enabling device 100 to verify signature values 312. As an example, when the software module is an update module, the public key of the update software module differs from the public key of the software module of the previous version of the application. Indeed, if the update module is, for example, signed by a supplier different from the later version, the symmetric key as well as the identification value 310 differ from those of the later version. Thus, the calculated encryption key will also be different from that calculated for the later version. The assets stored in the non-volatile memory, in association with the later version, will then no longer be able to be decrypted by means of the encryption key and, accordingly, will no longer be able to be used. As an example, the verification of the signature values enables device 100 to ensure the trustworthiness of software module 300 and to authenticate the authority having constructed software module 300.

According to an embodiment, identification value 310 corresponds to the public key to which a cryptographic operation is applied. As an example, identification value 310 is a hash of public key 314. Identification value 310 is, for example, obtained by application of a hash operation, for example SHA256, to public key 314.

Software module 300 further comprises information 315 associated with the original equipment manufacturer. As an example, information 315 comprises another signature value 316 (OEM SIGNATURE). As an example, this other signature is associated with an original equipment manufacturer. As an example, this other signature enables the original equipment manufacturer to control the installation of application modules originating from a third party. As an example, an application module is then installed only in the case where the value of this other signature is correct. As an example, when the application module originates from the original equipment manufacturer, the identification value is omitted or is aligned with the public key of the original equipment manufacturer, identification value 310 being, for example, a hash of the public key of the original equipment manufacturer. In this example, the public key of the original equipment manufacturer is provisioned on manufacturing of device 100.

FIG. 4 is a flowchart illustrating steps of a verification method, according to an embodiment of the present disclosure.

As an example, all or part of the steps described in relation with FIG. 4 are implemented via electronic device 100, and for example by the software platform 201 of FIG. 2. In other words, all or part of the actions performed by electronic device 100, such as, for example, cryptographic operations by circuit(s) 116; the writing into, or the reading from, memories 203; etc., are controlled by software platform 201.

At a step 400 (RECEPTION MODULE), a software module of an application, similar to the software module 300 described in relation with FIG. 3, is received by device 100. As an example, the software module of the application is received as a result of a wireless communication, for example, a communication of Wifi, Bluetooth, 4G, or 5G type, etc. In another example, the software module is received by wired communication. As an example, the reception of the software module of the application is initiated by the manufacturer of device 100. In another example, the reception of the software module of the application is initiated by a user of device 100. In an example, the received software module of the application is an update of an application already installed in device 100. In another example, the received software module of the application enables the installation of a new application in device 100.

At a step 401 (AUTHENTICITY VERIFICATION), the authenticity and/or the integrity of the software module is verified by device 100, in particular via processor 101 and cryptographic circuit(s) 106. As an example, the verification is carried out by verification of signatures 312 and/or 316 and, for example, based on public key 314. Step 401 is carried out, for example, during a start-up phase of device 100.

According to an embodiment, for example when the software module originates from a third party and comprises identification value 310, step 401 further comprises the generation of a verification value by applying a cryptographic operation, via circuit(s) 106, on public key 314, such as for example a hash operation, such as SHA256. In another example, when the application module originates from the original equipment manufacturer, the cryptographic operation is performed on a public key associated with the original equipment manufacturer provisioned in device 100 on manufacturing thereof. Step 401 then comprises the verification of the verification value with identification value 310. As an example, in the case where the two values do not match, the software module of the application is not installed and is, for example, removed from device 100.

In the alternative case where identification value 310 is not comprised in the software module, a step 402 (SIGNER ID) comprises the generation, by circuit(s) 106, of identification value 310. For example, the identification value is generated directly from public key 314 or from the public key associated with the original equipment manufacturer.

At a step 403 (KEY GENERATION), an encryption key is generated, based on identification value 310, comprised in the software module or generated at step 402, and on a secret key of device 100. As an example, the encryption key is generated by application of a cryptographic operation, such as a symmetric encryption operation, for example of AES, DES, etc. type, to identification value 310 and with the secret key. As an example, the secret key is a hardware unique key, or a key derived from a hardware unique key. In other words, the secret key is unique to device 100, the generated encryption key is thus also unique and specific to device 100. For a same software module of the application, the generated encryption key differs from one device 100 to another. Similarly, for a same device 100, the encryption keys generated for two software modules originating from different suppliers, for example originating from a third party and from the original equipment manufacturer, differ.

At a step 404 (SECRETS GENERATION), the generated encryption key is used to generate one or a plurality of protected data, or secrets, associated with the application.

In an example, the generated encryption key is used to encrypt, for example according to a symmetric cryptography algorithm, one or a plurality of the digital assets of the application. In another example, the generated encryption key is used to calculate one or a plurality of signature values of one or a plurality of digital assets. Thus, the encryption key depending on the software module and on the device receiving it, the secrets generated at step 404 are also specific to the application and to device 100.

At a step 405, the protected data or secrets generated at step 404 are stored in a first portion of memories 203. As an example, the execution code of the software module is, for example, stored at step 405 in a second portion of the memory, distinct from the first portion where the protected data associated therewith are stored. As an example, the execution code of the module is encrypted and the software platform 201 controls, for example, its decryption by the cryptographic circuit and then the storage of the decrypted code.

As an example, in an optional step 406 (EXECUTE), the execution code installed in the second portion of the memory is executed. As an example, during the execution, platform 201 controls the retrieval of the digital assets stored in the first portion of memory 203. For this purpose, platform 201 controls, for example, the retrieval of identification value 310, or of symmetric key 314 from the execution code. As an example, as a result of the authentication of the code, the area containing identification value 310 and/or public key 314 is prohibited. The encryption key is generated again to be able, for example, to perform the decryption of the protected data to obtain the digital assets. In another example, the encryption key generated again is used to verify the signature value(s) associated with the assets.

An advantage of the described embodiments is that a first application cannot have knowledge of the values of the digital assets associated with another application different from the first application.

Another advantage of the described methods is that the encryption key used to encrypt or to sign the assets is not stored in the memory. Indeed, the encryption key is for example calculated at each start-up phase of device 100.

Various embodiments and variants have been described. Those skilled in the art will understand that certain features of these various embodiments and variants may be combined, and other variants will occur to those skilled in the art. In particular, the generation of the encryption key based on the public key may vary.

Finally, the practical implementation of the described embodiments and variants is within the abilities of those skilled in the art based on the functional indications given hereabove. In particular, regarding the implementation of the software platform.

1. A method, comprising:
a) receiving, by an electronic device, a software module of a first application, the software module comprising a public key associated with the first application;
b) generating, by a cryptographic circuit of the electronic device, an encryption key based on both a secret key of the electronic device and one of: a public key or an identification value derived from the public key;
c) generating, by the cryptographic circuit, one or a plurality of protected data items by applying a cryptographic operation on one or a plurality of first data items associated with the first application and based on the encryption key; and
d) storing the one or plurality of protected data items in a first portion of a memory of the electronic device.

2. The method according to claim 1, wherein the cryptographic operation comprises encrypting, by using the encryption key, the one or plurality of first data items.

3. The method according to claim 1, wherein the cryptographic operation comprises calculating one or a plurality of first signature values associated with the one or plurality of first data items by using the encryption key, the one or plurality of protected data items comprising the one or plurality of first signature values.

4. The method according to claim 1, wherein the encryption key corresponds to a secret key derived by applying a key derivation function by the cryptographic circuit based on the identification value, the identification value resulting from a hashing of the public key.

5. The method according to claim 1, wherein the software module comprises an execution code, and a second signature value associated with the execution code, the method further comprising, prior to generating the one or plurality of protected data items, authenticating the software module based on a verification of the second signature value via the public key.

6. The method according to claim 5, further comprising storing the execution code in a second portion of the memory distinct from the first portion.

7. The method according to claim 1, wherein steps a) to d) are carried out via a software platform of the electronic device.

8. The method according to claim 1, further comprising, prior to carrying out step b):
generating a verification value by applying a hash function to the public key;
comparing the verification value with the identification value; and
when the verification value and the identification value do not match, removing the software module.

9. The method according to claim 1, further comprising generating, by the cryptographic circuit, the identification value by applying a hash function to the public key.

10. The method according to claim 1, wherein the secret key of the electronic device is one of: a hardware unique key or a key derived from a hardware unique key.

11. The method according to claim 1, further comprising modifying the public key during an update of the first application.

12. The method according to claim 1, further comprising executing, by a processor of the device, the first application by retrieving the one or plurality of first data items associated with the first application, by:
extracting the public key and performing a new generation of the encryption key based on both a secret key of the electronic device and one of: the public key or an identification value derived from the public key;
applying a new cryptographic operation to the one or plurality of protected data items stored in the first portion of the memory; and
retrieving the one or plurality of first data items.

13. The method according to claim 12, wherein retrieving the one or plurality of first data items is performed via a software platform of the electronic device.

14. An electronic device, configured to receive a software module from a first application, the software module comprising a public key, the electronic device comprising:
a cryptographic circuit configured to:
generate an encryption key based on one of: a public key or an identification value derived from the public key;
generate one or a plurality of protected data items by applying a cryptographic operation to one or a plurality of first data items associated with the first application based on the encryption key; and
a memory configured to store the one or the plurality of protected data items.

15. The electronic device according to claim 14, further comprising a software platform configured to control the access to the memory.

16. The electronic device according to claim 14, wherein the cryptographic operation comprises an encryption, by using the encryption key, of the one or plurality of first data items.

17. The electronic device according to claim 14, wherein the cryptographic operation comprises a calculation of one or a plurality of first signature values associated with the one or plurality of first data items by using the encryption key, the one or plurality of protected data items comprising the one or plurality of first signature values.

18. The electronic device according to claim 14, wherein the secret key of the electronic device is one of: a hardware unique key or a key derived from a hardware unique key.
